(19) United States
(12) Patent Application Publication
(10) Pub. No.: US 2007/0277740 A1
(43) Pub. Date: Dec. 6, 2007

(54) LITTER BOX

(75) Inventors: Joel G. Delman, Los Angeles, CA (US); Lisa Ann Yanz, Chicago, IL (US); Carolyn Anne Rose, Chicago, IL (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/733,666

(22) Filed: Apr. 10, 2007

Related U.S. Application Data
(60) Provisional application No. 60/803,548, filed on May 31, 2006.

(51) Int. Cl. A01K 29/00

(52) U.S. Cl. 119/165

(57) ABSTRACT

A litter box including a housing having a curved floor and a plurality of walls extending from the curved floor.

### CROSS REFERENCE TO RELATED APPLICATIONS

This application claims the benefit of U.S. Provisional Patent Application No. 60/803,548, filed May 31, 2006, the disclosure of which is hereby incorporated herein by reference in its entirety.

### FIELD OF THE INVENTION

The present invention relates to a litter box, and more specifically, to a curved litter box.

### BACKGROUND OF THE INVENTION

Litter boxes are common features in homes that have cats or other small indoor pets. These pets are specifically trained to use the litter box for waste elimination. Owners of these pets must then maintain the litter box so that the pet has a clean and sanitary environment. Oftentimes these litter boxes require some work to fully remove all waste products.

A typical litter box is a small rectangular container and filled with litter. A user may clean the litter box by using a slotted scoop to scrape away and sift out waste material, such as fecal matter or agglomerated clumps caused by urine soaking the litter. The slotted scoop scrapes along the flat bottom of a typical litter box to remove waste therefrom. As the user cleans the litter box, the waste matter may gather in the corners of the box, making it difficult to fully remove.

In an attempt to make this process easier, plastic litter liners have been developed to help keep litter and waste matter from sticking to the litter box. However, the litter liners still need to be scraped and the litter still needs to be sifted to clean the box. Further, a pet owner still needs to scrape and scoop in all directions to search for material that needs to be removed.

There is a need in the art for a litter box that allows for easier scraping and cleaning.

### SUMMARY

One embodiment of the present invention takes the form of a litter box. The litter box includes a housing having a curved floor and a plurality of walls extending from the curved floor.

Another embodiment of the present invention takes the form of a method of manufacturing a litter box. The method includes forming a container having a curved floor and a plurality of walls that extend from the curved floor, wherein the plurality of walls terminate in an edge that is spaced apart from the curved floor.

As will be realized by those of ordinary skill in the art upon reading the entirety of this disclosure, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of a litter box.

FIG. 2 is a side view of a housing of the litter box in FIG. 1.

FIG. 3 is perspective view of the housing of the litter box.

FIG. 4 is a flow chart of a method of manufacturing a litter box.

### DETAILED DESCRIPTION

The present invention discloses an exemplary litter box kit 5. The litter box kit 5 includes a litter box with a curved floor. The curved floor is further discussed below.

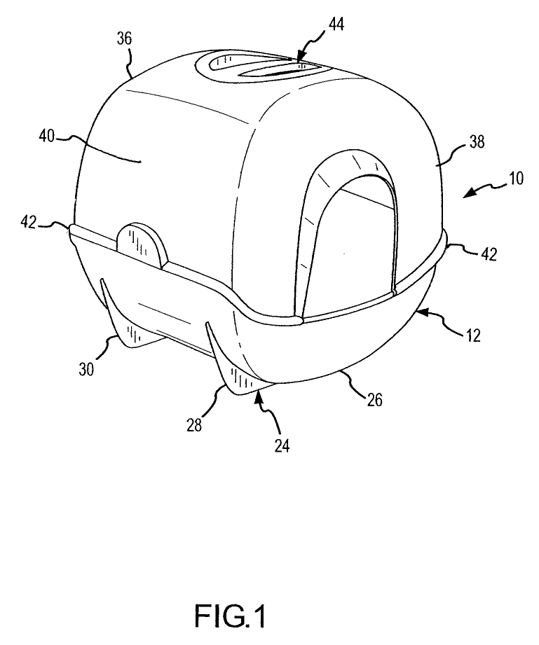

The litter box 10 is now discussed with respect to FIG. 1. FIG. 1 is a perspective view of the litter box 10. In one embodiment, the litter box 10 may include a housing 12 and a hood or cover 14. The hood 14 is coupled to the housing 12.

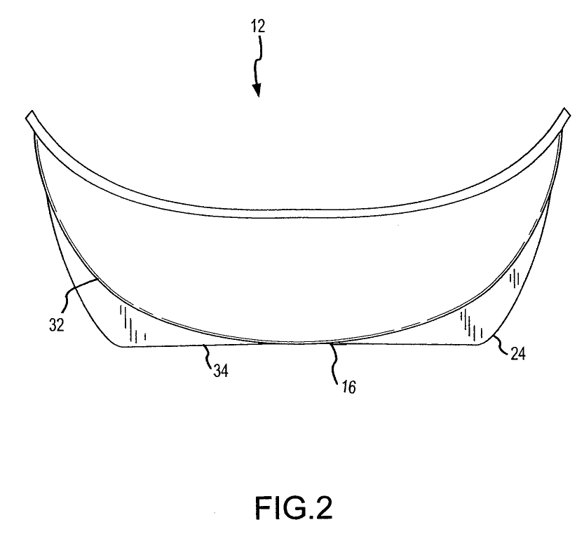

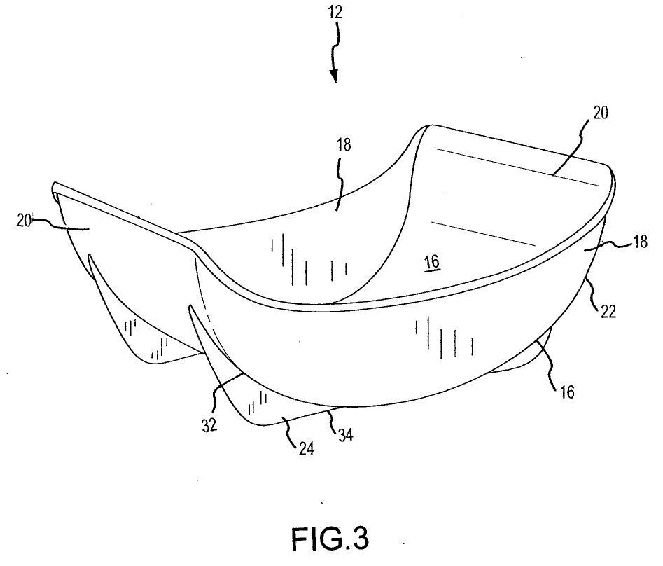

As best shown in FIGS. 2-3, the housing 12 has a semi-cylindrical or curved floor 16 and two end walls 18 extending therefrom to create a litter box setting. The curved floor 16 extends in an upward direction to form two arched or curved sidewalls 20, terminating in a peripheral edge 22. The curved floor and the side walls may be configured such that their formation produces no interior corners in the exemplary embodiment. The end walls 18 join the curved sidewalls in forming the peripheral edge. The end walls may also be curved or arched. The end walls and the curved floor may be configured such that their formation include no interior corners in the exemplary embodiment.

The housing 12 may be made of a polymeric material. For example, the housing 12 may be formed of a styrene material or a polypropylene material, among other materials.

As shown in FIGS. 2-3, the housing 12 includes a stand assembly 24. The stand assembly 24 is coupled to an outer surface 26 of the curved floor 16. The stand assembly 24 may be molded or affixed to the curved floor 16. The stand assembly 24 supports the curved floor 16 and stabilizes the housing when resting on a generally flat support surface. The stand assembly 24 may include a first stand member 28 and a second stand member 30. Each stand member 28, 30 includes a first surface 32 and a second surface 34. The first surface 32 is concave to contour to the outer surface of the curved floor 16. The second surface 34 is typically flat to rest stability on the support surface. Alternatively, the housing may include a plurality of legs to support and stabilize the housing when resting on a generally flat support surface. Either the stand assembly or legs may include frictional surfaces to minimize slippage when the litter box is placed on a surface. Exemplary frictional surfaces include rubber or roughened feet, or feet formed from another suitable material such as a soft plastic, thermoplastic or suitable resin.

The stand assembly 24 may be made of a polymeric material, such as a styrene material or a polypropylene material. Alternatively, the stand assembly 24 may be made of a metal or a wood material among other materials.

Referring to FIG. 1, the hood 14 covers the housing 12. The hood 14 includes a curved or semi-cylindrical ceiling 36 and end walls 38 extending therefrom. The curved ceiling 36 extends in a downward direction forming curved or arched sidewalls 40 that terminate in a peripheral edge 42. The end walls 38 form a portion of the peripheral edge 42. An opening or doorway 43 may be formed in at least one of the end walls 38.

The hood 14 is rotatable to allow opening and manipulation thereof. The hood 14 includes a handle 44. The handle 44 allows a user to manipulate the hood 14 for easy installation and removal.

The hood 14 may be made of a polymeric material. For example, the hood 14 may be made of a styrene material or a polypropylene material among other materials. In addition, the hood 14 (or another portion of the litter box 10, such as a wall) may include a filter opening or chamber (not shown). The filter chamber may be formed in the hood and accept a filter for reducing or eliminating odors from used litter or animal waste. One exemplary filter is made of charcoal.

The litter box kit 5 may also include a litter scoop (not shown). A portion of the litter scoop may be curved to match contours of the floor 16 and arched walls. As the scoop neatly matches the floor 16, the scoop allows for clean and easy sifting of the litter and gathering of waste material.

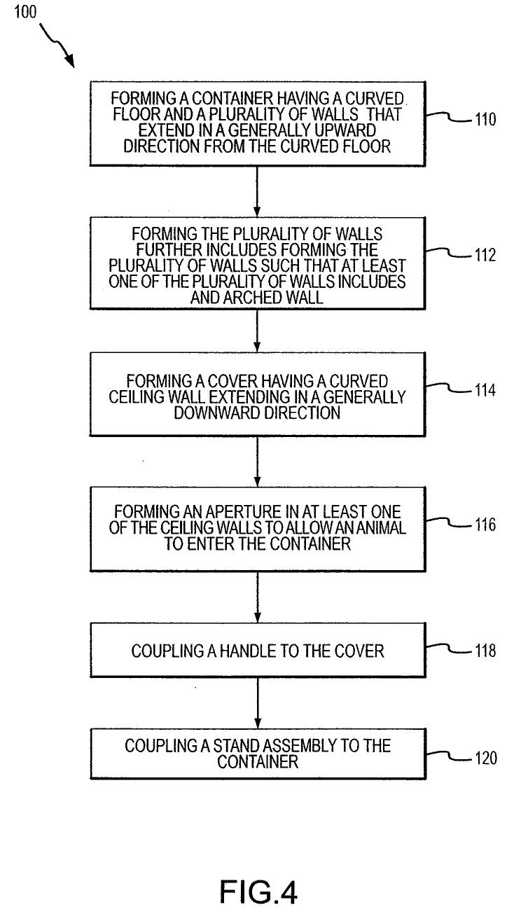

As shown in FIG. 4, another embodiment of the present invention may take the form of a method 100 of manufacturing a litter box. The method 100 includes forming a container having a curved floor and a plurality of walls that extend in a generally upward direction from the curved floor at operation 110. The operation 110 of forming the plurality of walls further includes forming the plurality of walls such that at least one of the plurality of walls includes an arched wall. Alternatively, the arched wall may be formed separately, as in operation 112, and affixed or attached to the curved floor. The plurality of walls terminates in an edge that is spaced apart from the floor.

The method 100 may also include forming a cover having a curved ceiling wall extending in a generally downward direction at operation 114. The curved ceiling wall terminates in a second edge that is spaced apart from the ceiling. The covering is also adapted to couple to the container.

The method 100 may include forming an aperture in at least one of the ceiling walls to allow an animal to enter the container at operation 116. As an alternative, a wall may be molded in such a manner that the aperture is formed therein and no separate operation is necessary to form the aperture. Additionally, the method 100 may include coupling a handle to the cover 118. The method may further include coupling a stand assembly to the container at operation 120.

Generally, the various forming operations discussed herein may take the form of molding the litter box elements from a plastic, resin, or other suitable material.

Although the present invention has been described with reference to preferred embodiments, persons skilled in the art may recognize that changes may be made in form and detail without departing from the spirit and scope of the invention.

What is claimed is:

1. A litter box comprising:
a curved floor; and
a plurality of walls extending in an upward direction from the curved floor.

2. The litter box of claim 1, further comprising a hood coupled to the housing.

3. The litter box of claim 2, wherein the hood has at least one aperture configured to allow an animal to enter.

4. The litter box of claim 2, wherein at least a portion of a peripheral edge for the hood and at least a portion of a peripheral edge for the housing define an aperture configured to allow an animal to enter.

5. The litter box of claim 2, wherein the hood comprises a handle.

6. The litter box of claim 2, wherein the hood comprises:
a curved ceiling and
a plurality of ceiling walls extending in a downward direction from the curved ceiling.

7. The litter box of claim 6, wherein at least one of the plurality of ceiling walls comprises an arched ceiling wall.

8. The litter box of claim 2, wherein the hood is rotatably coupled to the plurality of walls.

9. The litter box of claim 1, wherein at least one of the plurality of walls includes an arched wall.

10. A method of manufacturing a litter box, comprising:
forming a container having a curved floor and a plurality of walls that extend in an upward direction from the curved floor, the plurality of walls terminating in an edge that is spaced apart from the curved floor.

11. The method of claim 10, further comprising:
forming a cover having a curved ceiling and a plurality of ceiling walls that extends in a downward direction terminating in a second edge that is spaced apart from the ceiling, wherein the cover is adaptive for coupling to container.

12. The method of claim 11, wherein at least one of the plurality of ceiling walls comprises an arched ceiling wall.

13. The method of claim 11, wherein forming the cover further comprising configuring the cover such that the cover is removably coupled to the container.

14. The method of claim 11, wherein forming the cover further comprising configuring the cover such that at least one of the ceiling walls form an aperture to allow an animal to enter the container.

15. The method of claim 11, wherein the cover comprises a polymeric material.

16. The method of claim 11, further comprising:
coupling a handle to the cover.

17. The method of claim 10, wherein at least one of the plurality of walls comprises an arched wall.

18. The method of claim 10, further comprising:
coupling a stand assembly to the container.

19. The method of claim 10, wherein the container comprises a polymeric material.
